(19) United States
(12) Patent Application Publication
(10) Pub. No.: US 2011/0289736 A1
(43) Pub. Date: Dec. 1, 2011

(54) METHOD AND APPARATUS FOR COVERING AN END OF A CABLE EXTENDING FROM A FORM DURING THE MANUFACTURE OF MOLDED STRUCTURAL MEMBERS

(75) Inventor: Robert C. GRASSER, Reinholds, PA (US)

(73) Assignee: HIGH CONCRETE GROUP LLC, Lancaster, PA (US)

(21) Appl. No.: 13/108,145

(22) Filed: May 16, 2011

Related U.S. Application Data
(60) Provisional application No. 61/347,894, filed on May 25, 2010.

(51) Int. Cl. F16G 11/00; B29C 39/18; H01F 7/02

(52) U.S. Cl. 24/303; 24/129 R; 264/279; 249/96

(57) ABSTRACT

A cap includes a resilient body including a passageway formed in the body for receiving an end of a cable therein. The passageway has a retention feature for maintaining the cable end of a horizontally extending cable inside the passageway from inadvertent separation with the passageway.

### RELATED APPLICATION

This application claims priority to U.S. Provisional Patent Application Ser. No. 61/347,894, filed May 25, 2010, entitled “Method And Apparatus For Covering An End Of A Cable Extending From A Form During The Manufacture Of Molded Structural Members.”

### FIELD

The disclosure relates to a method and apparatus for covering an end of a cable extending from a form during the manufacture of molded structural members. More particularly, the present disclosure is directed to an apparatus and method for manufacture of a cover for covering the ends of cables associated with concrete structures.

### BACKGROUND

Concrete structural members include structural tees, panels, and connections between girders and columns to help assemble or reinforce the structural members together. These structural members may include cables embedded within the structural members that are subjected to tensile loading in order to increase the load carrying capacity of the structural members.

To maximize efficiencies associated with the manufacture of the structural members, pouring forms from which the structural members are manufactured are aligned between adjacent aisles of a manufacturing facility, with contiguous lengths of cables extending through the forms and spanning the aisles. During a subsequent manufacturing step, cables are cut between adjacent forms using a cable saw, the resulting ends of the cables having a “sharpened edge” with the potential for injury as a result of even incidental contact with the cable ends.

At the time of this writing, in an effort to minimize the possibility of injury, caps may be installed over the ends of the cables as provided by the Occupational Safety & Health Administration (OSHA), Title 29 of The Code Of Federal Regulations (CFR), Part 1926—Safety and Health Regulations for Construction, Subpart Q—Concrete And Masonry Construction. However, this portion of the OSHA regulations is directed to vertically extending rebar and the like, in an effort to prevent impalement, such as by falling on the vertically extending rebar. While caps as provided under the above-referenced regulations appear to function well for vertically extending rebar, the caps do not appear to function well for horizontally extending cables. In other words, the caps configured in accordance with the above-referenced regulations are primarily maintained in position by virtue of gravity for vertically extending rebar, and do not reliably remain in position at the end of a horizontally oriented cable, or worse, a cantilevered horizontally oriented cable, in which the end of the cable contains a downwardly directed slope below horizontal. Stated another way, the caps configured in accordance with the above-referenced regulations may be over-sized with respect to the horizontally oriented cable, and lack a sufficient frictional component in order to prevent inadvertent or unintended removal of the cap from the end of the horizontally extending cable.

What is needed is a cap that is configured for installation over an end of a horizontally extending cable that will reliably remain in an installed position over the cable end in order to prevent injury associated with contacting the cable end, is inexpensive to manufacture and reusable.

### SUMMARY

The present invention includes a cap having a resilient body including a passageway formed in the body for receiving an end of a cable therein. The passageway has a retention feature for maintaining the cable end of a horizontally extending cable inside the passageway from inadvertent separation with the passageway.

The present invention further includes an apparatus for forming a cap including a base and an elongated member extending outwardly from the base. A tube has an end for placement of the tube over the member, the tube forming a substantially fluid tight seal with the base. The tube is configured to receive a liquid material between the tube, the member and the base to form a cap upon curing, the cap includes a resilient body including a passageway formed in the body for receiving an end of a cable therein. The passageway has a retention feature for maintaining the cable end of a horizontally extending cable inside the passageway from inadvertent separation with the passageway.

The present invention still further includes a method for forming a protective cap configured for covering an end of a horizontally extending cable from inadvertent separation therebetween. The method further includes providing a base having an elongated member extending outwardly from the base and positioning a tube having an end over the member, the end forming a substantially fluid tight seal with the base. The method further includes pouring sufficient liquid material between the tube, the member and the base to cover the member. The method further includes curing the liquid material to form the cap and separating the cap from the member and the base.

An advantage is a cap that is configured for installation over an end of a horizontally extending cable that will reliably remain in an installed position over the cable end in order to prevent injury associated with contacting the cable end.

A further advantage is a cap configured for installation over an end of a horizontally extending cable that is inexpensive to manufacture.

A still further advantage is a cap configured for installation over an end of a horizontally extending cable that is reusable.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 is a top perspective view of a structural member manufactured using the present disclosure.

FIG. 2 is an arrangement of forms to manufacture the structural member of FIG. 1.

FIG. 3 is an arrangement of forms to manufacture the structural member of FIG. 1, using the present disclosure.

FIG. 4 is an exemplary embodiment usable to fabricate a cap of the present disclosure.

FIG. 5 is a cross section taken along line 5-5 of FIG. 4.

FIG. 6 is a further embodiment usable to fabricate a cap of the present disclosure.

FIG. 7 is a cross section taken along line 7-7 of FIG. 6.

Wherever possible, the same reference numbers will be used throughout the drawings to refer to the same or like parts.

### DETAILED DESCRIPTION

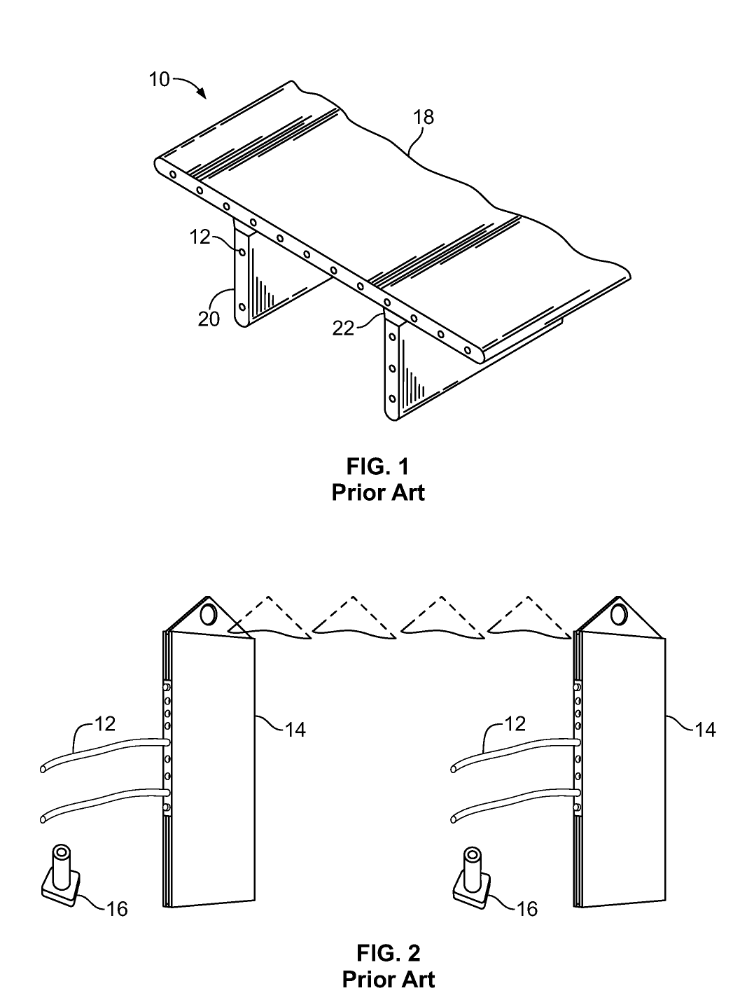

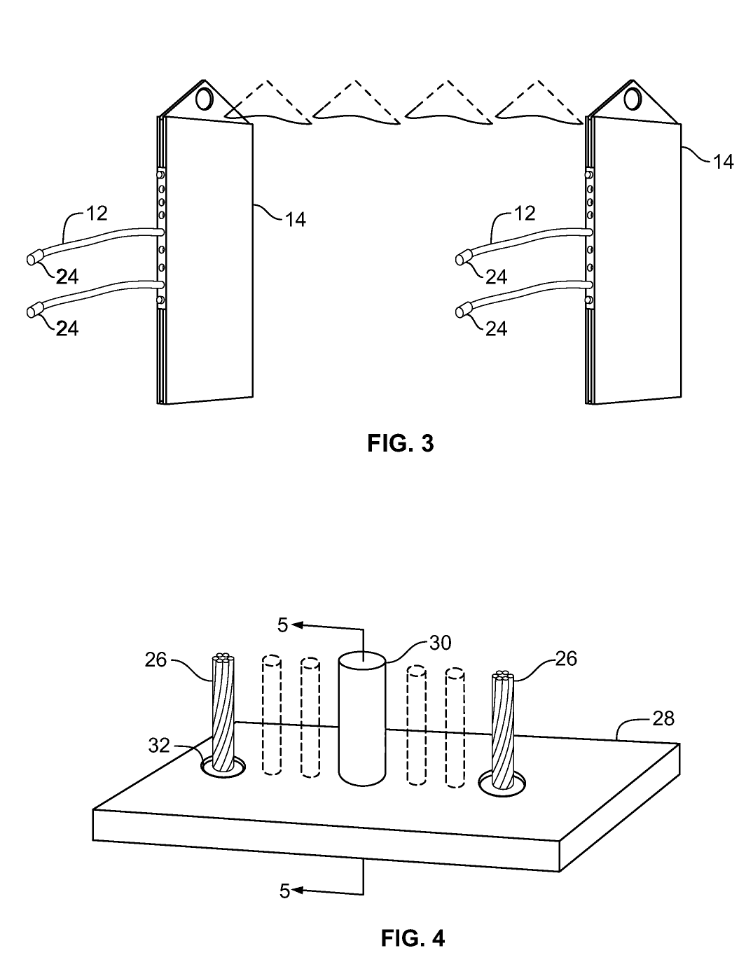

Referring to FIGS. 1-3, the present disclosure is directed to an apparatus and/or method for fabricating a product 10 including a product positioned in a form 14 into which material is poured, and upon curing of the material, produces the product. In an exemplary embodiment, the material to be poured in the form is cement (forming concrete upon curing), and the product formed is a concrete structural member, such as a Tee beam, also referred to as a T-beam or double Tee block (shown in FIG. 1), panels or connections between girders and columns. As shown, multiple forms 14 may be located in close proximity to each other to maximize efficiencies associated with fabrication of the T-beams. Cables 12 are embedded within the structural members and subjected to tensile loading in order to increase the load carrying capacity of the structural members. As shown in FIG. 2, caps 16, which are configured for use with vertically extending rebar for purposes of preventing impalement, but which caps are not configured for use with horizontally extending cables, and more specifically, not configured for use with cantilevered horizontally extending cables, are shown resting on the floor, having slid off the cable ends, exposing the cable ends for possible injury. In contrast, as shown in FIG. 3, caps 24, each of which caps having a body including a passageway that may be configured for use with horizontally extending cables 12 or cantilevered horizontally extending cables, will remain reliably secured to the end of the cables.

FIG. 1 further shows a cast concrete T-beam 10 having an essentially flat supporting top panel 18 and a pair of dependent legs 20 extending downwardly from the panel. Reinforcing tension cables 12 may be embedded in the beam as shown.

T-beams 10 are cast using a mold or form defining the shape of the legs and the lower surface and sidewalls of the top panel. FIG. 2 illustrates the portion of the form 14 used to form one leg 20 (FIG. 1) or the knee junction with the top panel. Cables 12 are rigged and guides 22 (FIG. 1) are positioned in the knee portions of the form at intervals along the length of the legs where openings will be required in the completed beam for utility wires, conduits, water lines, and the like.

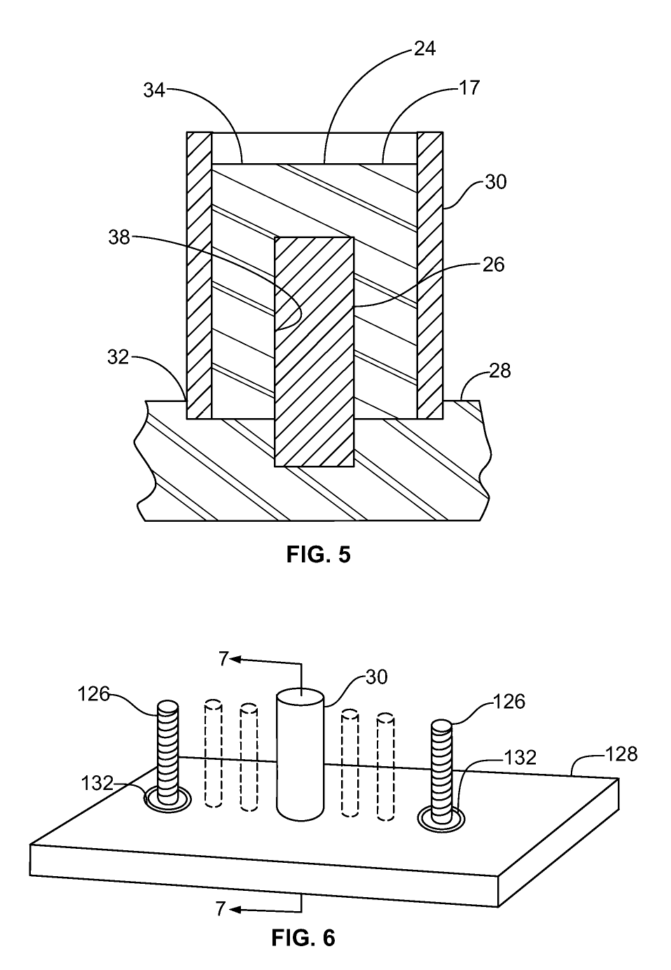

FIGS. 4-5 show an exemplary apparatus configured to manufacture caps of the present disclosure. Elongated members 26, such as cable segments corresponding in size to tension cables 12 (FIG. 1) are mounted in a base 28 configured to accommodate multiple cable segments. In one embodiment, elongated members or cable segments 26 are of the same diameter, such as ⅜ of an inch, although the cable segments may be of different diameters or define non-circular profiles, as desired or needed. A tube 30 is configured to slide over a corresponding elongated member or cable segment 26. In one embodiment, each cable segment 26 is associated with a positioning feature 32, such as a recess-sized to receive one end of tube 30. In a further embodiment, positioning feature or recess 32 is a counterbore configured such that tube 30 concentrically surrounds the cable segment. After tube 30 is positioned over a corresponding cable segment 26 and secured to base 28 using the positioning feature 32, a body 17 including a liquid material 34 poured into the tube until the level of material is above the top surface of the cable segment. In other words, material 34 completely surrounds the exposed portion of cable segment 26, that is the portion of the cable segment that extends outwardly from base 28. In one embodiment, material 34 is an elastic and resilient material.

Upon curing, material 34 is collectively separated from tube 30, cable segment 26 and base 28, forming a cylindrical cap 24 (also see FIG. 3). In another embodiment, cap 24 may include other shapes, depending upon the profile of tube 30. The resilient cap 24, despite retaining the helical profile of cable segment 26 along the inner surfaces of cap 24 during its fabrication and forming a frictional contact with an outer surface of an end of a cable, such as horizontally extending cable 12 (FIG. 2), should relatively easily slide over an end of the cable. However, by virtue of being molded over an elongated member or cable segment of substantially the same or smaller size, resilient cap 24 should provide a conformal fit over an end of a cable that should typically require a removal force greater than the weight of the cap to separate the cap from the cable. To further achieve reliable retention of cap 24 over the cable end, material 34 should be composed of a material having an enhanced coefficient of static friction with respect to cable material such as a polymer. In one embodiment, the polymer is a rubber material. In addition, by virtue of cap 24 having a closed end and forming a conformal fit over a cable end, such insertion of the cap over the cable end may require overcoming a vacuum force to effect separation between the cap and the cable end. In another embodiment, cap 24 may be formed using a cable segment 26 that is of a cross sectional area, typically a diameter, that is less than the cross sectional areas of corresponding cable ends over which the cap is manually installed over, resulting in the cap applying a compressive force against the cable end, in addition to the enhanced coefficient of static friction between the cap and the cable end, resulting in the cap forming a further reliable fit with respect to the cable end.

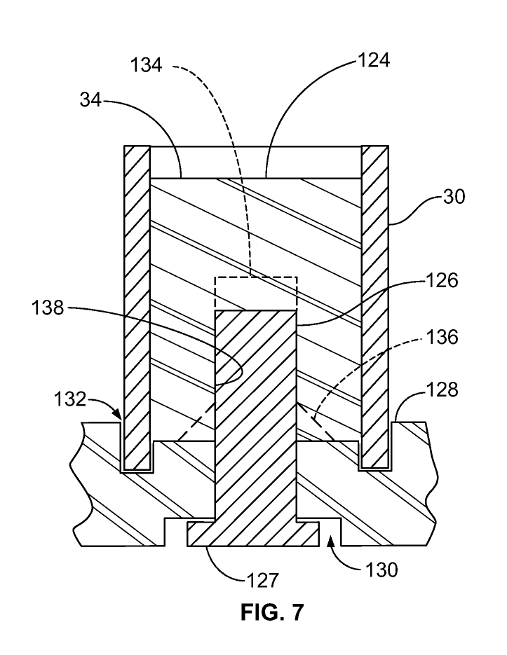

FIGS. 6-7 show an alternate embodiment of an apparatus configured to manufacture caps of the present disclosure. Elongated members 126, such as mechanical fasteners including a bolt or screw, corresponding in size to tension cables 12 (FIG. 1) are mounted in a base 128 configured to accommodate multiple elongated members. As further shown in FIG. 7, a head 127 of elongated member 126 is received by a recess 130 formed in base 128, with the elongated member extending through the base. In one embodiment, elongated members or mechanical fasteners 126 are of the same diameter, such as ⅜ of an inch, although the mechanical fasteners may be of different diameters or define non-circular profiles, as desired or needed. A tube 30 is configured to slide over a corresponding elongated member or mechanical fastener 126. In one embodiment, each elongated member or mechanical fastener 126 is associated with a positioning feature 132, such as a recess sized to receive one end of tube 30. In a further embodiment, recess 132 is a counterbore configured such that tube 30 substantially concentrically surrounds the cable segment. In yet a further embodiment, recess 132 can be an annular ring that receives one end of tube 30. After tube 30 is positioned over a corresponding elongated member or mechanical fastener 126 and secured to base 128 using the positioning feature, liquid material 34 is poured into the tube until the level of the material is above the top surface of the elongated member. In other words, material 34 completely surrounds the exposed portion of elongated members or mechanical fasteners 126 that extend outwardly from base 128.

Upon curing from a liquid phase to a solid phase, material 34 is collectively separated from tube 30, elongated member 126 and base 128, forming a cylindrical cap 124 (also see FIG. 3). In another embodiment, cap 124 may include other shapes, depending upon the profile of tube 30 and elongated member 126. For example, elongated member 126 may be a dowel rod. In another embodiment, such as with a mechanical fastener or other arrangement, elongated member 126 may have a cross sectional area that is non-uniform when taken from a view similar to that taken along line 7-7 of FIG. 6, or substantially parallel to the longitudinal direction of the elongated member. In one embodiment, the non-uniform profile can resemble a ribbed profile. In a further embodiment, cured material 34 is an elastic and resilient material. The resilient cap 124, despite retaining the profile of elongated member 126, i.e., passageway 138 formed along the inner surfaces of cap 124 during its fabrication, should easily slide over an end of a cable, such as horizontally extending cable 12 (FIG. 2). As further shown in FIG. 7, an optional alignment feature 136, such as a tapered surface positioned along the junction of elongated member 126 and base 128 permits passageway 138 to be more easily guided over an end of a cable 12 (FIG. 2). However, by virtue of being molded over an elongated member or cable segment of substantially the same or smaller size, resilient cap 124 should provide a conformal fit over an end of a cable that should typically require a removal force greater than the weight of the cap. To further achieve reliable retention of cap 124 over the cable end, material 34 should be composed of a material having an enhanced coefficient of static friction with respect to cable material such as a polymer. In one embodiment, the polymer is a rubber material. In addition, by virtue of cap 124 having a closed end and forming a conformal and/or a compression fit between contacting surfaces of the cap and the cable over which the cap is slid over, such insertion of the cap over the cable end may require overcoming a vacuum force to effect separation between the cap and the cable end. In another embodiment, cap 124 may be formed using elongated member 126 having a cross sectional area, typically resembling a diameter, that is less than the cross sectional area of a corresponding contacting surface of a cable in close proximity of the cable end over which the cap is manually installed. The difference in cross sectional area results in the cap applying a compressive force against the cable end, in addition to the enhanced coefficient of static friction between the cap and the cable end. When such features are provided in combination, an enhanced retention of the cap with respect to the cable end results.

In an alternate embodiment, cap 24, 124 may be formed of a material having ferromagnetic properties, providing a magnetic attraction to the cable end. In a further alternate embodiment, a ferromagnetic material can be positioned in the cap. For example, in one embodiment a ferromagnetic material 134 (FIG. 7) can be placed in the liquid cap material prior to pouring the liquid cap material, such as placing the ferromagnetic material directly on the end of the elongated member or in close proximity thereof. Depending upon the strength of ferromagnetic material, a spacer (not shown) may be positioned between the end of the elongated member and the ferromagnetic material. In such constructions, the cross sectional area of the opening of the cap can be greater than the cross sectional area of the cable receiving the cap.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A cap comprising:
a resilient body including a passageway formed in the body for receiving an end of a cable therein, the passageway having a retention feature for maintaining the cable end of a horizontally extending cable inside the passageway from inadvertent separation with the passageway.

2. The cap of claim 1, wherein the horizontally extending cable is a cantilevered horizontally extending cable.

3. The cap of claim 1, wherein a cross sectional area of the passageway is substantially equal to or less than a cross sectional area of the cable.

4. The cap of claim 3, wherein the cable is composed of metal, the cable having at least one strand.

5. The cap of claim 4, wherein the retention feature has an enhanced static coefficient of friction value between the cable and the passageway.

6. The cap of claim 4, wherein separation of the cable end from the passageway requires overcoming a vacuum force.

7. The cap of claim 1, wherein the cable is composed of a ferromagnetic material and the body has ferromagnetic properties.

8. The cap of claim 1, wherein the cable is composed of a ferromagnetic material and a ferromagnetic material is positioned in the body.

9. The cap of claim 1, wherein the passageway is formed by casting the body over a segment of a cable.

10. The cap of claim 9, wherein the passageway is formed by casting the body over a segment of cable having at least one strand.

11. The cap of claim 1, wherein the passageway is formed by casting the body over a threaded mechanical fastener.

12. The cap of claim 8, wherein the ferromagnetic material is positioned in close proximity to the end of the cable when the end of the cable is at least partially inserted inside the passageway.

13. The cap of claim 12, wherein the ferromagnetic material is positioned in close proximity to the end of the cable when the end of the cable is substantially fully inserted inside the passageway.

14. An apparatus for forming a cap comprising:
a base;
an elongated member extending outwardly from the base;
a tube having an end for placement of the tube over the member, the tube forming a substantially fluid tight seal with the base, the tube configured to receive a liquid material between the tube, the member and the base to form a cap upon curing, the cap comprising:
a resilient body including a passageway formed in the body for receiving an end of a cable therein, the passageway having a retention feature for maintaining the cable end of a horizontally extending cable inside the passageway from inadvertent separation with the passageway.

15. The apparatus of claim 14, wherein separation of the cable end from the passageway requires overcoming a vacuum force.

16. A method for forming a protective cap configured for covering an end of a horizontally extending cable from inadvertent separation therebetween, comprising:
providing a base having an elongated member extending outwardly from the base;
positioning a tube having an end over the member, the end forming a substantially fluid tight seal with the base;
pouring sufficient liquid material between the tube, the member and the base to cover the member;
curing the liquid material to form the cap; and
separating the cap from the member and the base.

17. The method of claim 16, wherein the liquid material has ferromagnetic properties.

18. The method of claim 16, further including positioning a ferromagnetic material in the body prior to curing of the liquid material.

19. The material of claim 18, wherein positioning the ferromagnetic material includes locating the ferromagnetic material in close proximity with the member.

20. The material of claim 19, wherein positioning the ferromagnetic material includes locating the ferromagnetic material in close proximity with an end of the member opposite the base.
